(19) United States
(12) Patent Application Publication
(10) Pub. No.: US 2010/0039088 A1
(43) Pub. Date: Feb. 18, 2010

(54) INTERLEAVED SLAVE SWITCHING CIRCUIT FOR DISCONTINUOUS MODE PFC CONVERTER

(75) Inventor: Ta-Yung Yang, Milpitas, CA (US)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: SYSTEM GENERAL CORP., Taipei Hsien (TW)

(21) Appl. No.: 12/192,144

(22) Filed: Aug. 15, 2008

(51) Int. Cl. G05F 1/40

(52) U.S. Cl. 323/288

(57) ABSTRACT

A slave switching circuit for a master-slave PFC converter is disclosed. The slave switching circuit includes a phase-detection circuit coupled to detect a master-switching signal and a slave-inductor signal for generating a start signal and a phase-lock signal. The start signal is coupled to enable a slave-switching signal. The slave-switching signal is coupled to switch a slave inductor. An on-time-adjust circuit is used to adjust the on-time of the slave-switching signal in accordance with the phase-lock signal. The slave-inductor signal is correlated to the demagnetization of the slave inductor. The phase-lock signal is coupled to minimize the period between the disablement of the slave-inductor signal and the enablement of the start signal.

### BACKGROUND OF THE INVENTION

1. Field of the Invention

The present invention relates to a switching power converter, and more particularly to a control circuit of power factor correction (PFC) converters.

2. Description of the Related Art

A high current demand normally decreases the power efficiency in a power converter. The power loss of the power converter is exponentially proportional to its current.

P_{LOSS}=I²×R (1),

wherein I is a switching current of the power converter; R is an impedance of switching devices such as a resistance of an inductor and a transistor, etc.

Therefore, parallel technologies are developed for reducing the power consumption of the power converter. A PFC converter is utilized to improve a power factor of an AC power source. The detailed skill of a PFC circuit can be found in prior arts, such as U.S. Pat. No. 7,116,090, entitled “Switching Control Circuit for Discontinuous Mode PFC Converters”. The present invention is directed to develop an interleaved slave switching circuit for paralleling with a master switching circuit of the PFC converters to improve the efficiency of power supply. The technology of a master-slave circuit includes synchronization and phase interleaving which will spread switching noise and reduce ripples.

### SUMMARY OF THE INVENTION

The present invention provides a slave switching circuit for a master-slave PFC converter. The slave switching circuit includes a phase-detection circuit coupled to detect a master-switching signal and a slave-inductor signal for generating a start signal and a phase-lock signal. The start signal is utilized to enable a slave-switching signal. The slave-switching signal is coupled to switch a slave inductor. An on-time-adjust circuit is coupled to adjust the on-time of the slave-switching signal in accordance with the phase-lock signal. The slave-inductor signal is correlated to the demagnetization of the slave inductor. The phase-lock signal is coupled to minimize the period between disablement of the slave-inductor signal and enablement of the start signal. A power management circuit is utilized to decrease the on-time of the slave-switching signal when the on-time of the master-switching signal is decreased and the pulse width is lower than a threshold.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a master-slave PFC converter according to the present invention.

FIG. 2 shows an embodiment of a slave-switching circuit for the master-slave PFC converter according to the present invention.

FIG. 3 shows a phase-detection circuit according to the present invention.

FIG. 4 shows an embodiment of a phase-signal generator according to the present invention.

FIG. 5 shows a signal generator according to the present invention.

FIG. 6 shows a pulse-signal generator.

FIG. 7 shows key waveforms of signals according to the present invention.

FIG. 8 shows an embodiment of a lock-signal generator according to the present invention.

FIG. 9 shows an embodiment of an on-time-adjust circuit according to the present invention.

FIG. 10 shows a power management circuit according to the present invention.

### DESCRIPTION OF EMBODIMENTS

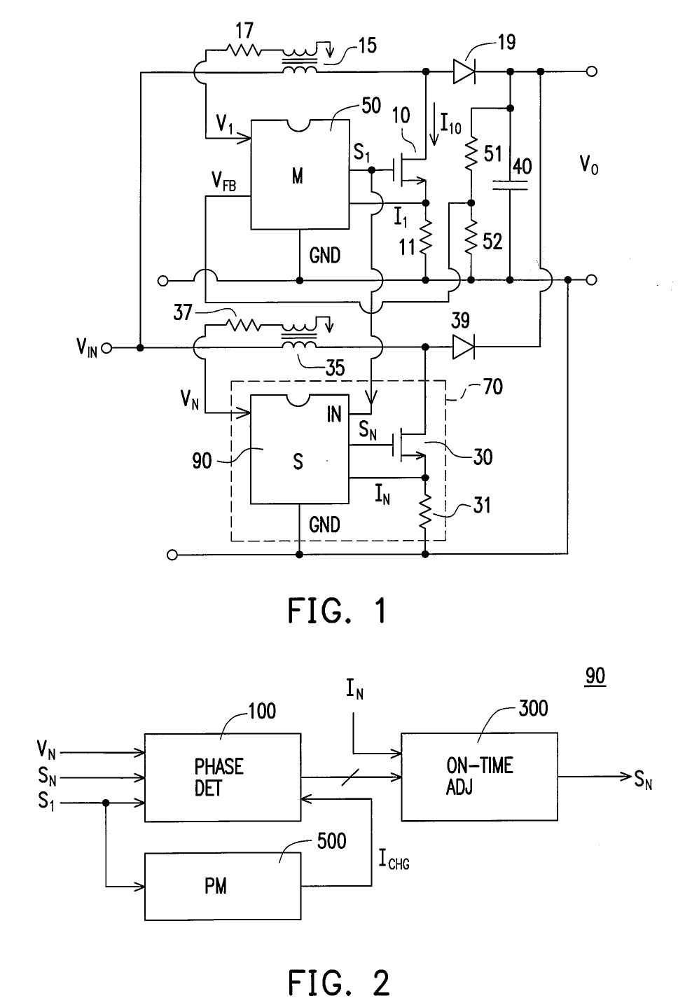

FIG. 1 shows a master-slave PFC converter according to the present invention. A master switching circuit 50, a transistor 10, a master inductor 15, and a rectifier 19 develop a master power converter. A master-switching signal S₁ is coupled to control the transistor 10 for switching the master inductor 15. The rectifier 19 and a capacitor 40 are utilized to generate an output voltage V_{O} of the PFC converter. A slave switching circuit 90, a transistor 30, a slave inductor 35, and a rectifier 39 develop a slave power converter coupled to the output voltage V_{O}. A slave-switching signal S_{N} is coupled to control the transistor 30 for switching the slave inductor 35. The outputs of the power converters are connected in parallel. The inductors 15 and 35 are connected to the output voltage V_{O}. The inductors 15 and 35 are further coupled to an input terminal VIN. When the transistor 10 is turned on, a switching current I₁₀ is generated. It is given by,

$${I}_{10} = \frac{{V}_{I N}}{{L}_{15}} \times {T}_{ON - 1} , \qquad ( 2 )$$

wherein the L₁₅ is the inductance of the master inductor 15; T_{ON-1} is the on-time of the master-switching signal S₁; V_{IN} is the voltage of the input terminal VIN. The “on-time” used here or hereafter means that a period when the transistor 10 is turned on.

A current-sense device such as a resistor 11 is coupled to sense the switching current I₁₀ for generating a master-current signal I₁. Another current-sense device such as a resistor 31 is coupled to sense the switching current of the transistor 30 and generate a slave-current signal I_{N}. The energy is stored into the master inductor 15 when the transistor 10 is on. Once the transistor 10 is turned off, the energy is delivered to the capacitor 40 through the rectifier 19. An auxiliary winding of the master inductor 15 generates a master-inductor signal V₁ correlated to the demagnetization of the master inductor 15. Besides, an auxiliary winding of the slave inductor 35 generates a slave-inductor signal V_{N} that is correlated to the demagnetization of the slave inductor 35.

FIG. 2 shows an embodiment of the slave-switching circuit 90. It generates the slave-switching signal S_{N} and includes a phase-detection circuit (“PHASE DET”) 100, an on-time-adjust circuit (“ON-TIME ADJ”) 300, and a power management circuit (“PM”) 500. The phase-detection circuit 100 is developed to generate a start signal CLK_{N} and a phase-lock signal UP/DWN by detecting the master-switching signal S₁ and a slave-inductor signal V_{N}. The start signal CLK_{N} and the phase-lock signal UP/DWN are coupled to the on-time-adjust circuit 300. The start signal CLK_{N} is utilized to enable the slave-switching signal S_{N}. The slave-switching signal S_{N} is coupled to switch the slave inductor 35 of FIG. 1. The on-time-adjust circuit 300 is applied to adjust the on-time of the slave-switching signal S_{N} in accordance with the phase-lock signal UP/DWN. The phase-lock signal UP/DWN is correlated to the period from the end of the slave-inductor signal V_{N} to the beginning of the start signal CLK_{N}. Therefore, the on-time of the slave-switching signal S_{N} is adjusted to minimize the period from the disablement of the slave-switching signal S_{N} to the enablement of the slave-inductor signal V_{N}. The current of the slave inductor 35 remains continuous if the transistor 30 is turned on instantly after the slave inductor 35 is demagnetized, which achieves a high power factor (PF) and low total harmonic distortion (THD).

The power management circuit 500 is coupled to receive the master-switching signal S₁ for generating a current signal I_{CHG} to decrease the on-time of the slave-switching signal S_{N} when the on-time of the master-switching signal S₁ is decreased and its pulse width is lower than a threshold.

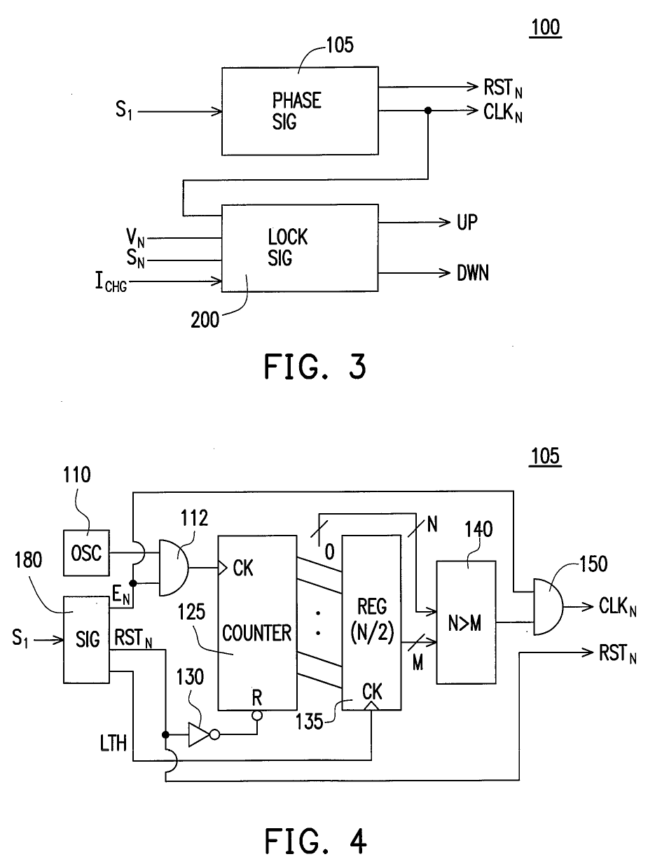

FIG. 3 shows an embodiment of the phase-detection circuit 100. It includes a phase-signal generator (“PHASE SIG”) 105 and a lock-signal generator (“LOCK SIG”) 200. The phase-signal generator 105 is used for generating the start signal CLK_{N} and a reset signal RST_{N} in accordance with the switching period of the master-switching signal S₁. The lock-signal generator 200 is used for generating the phase-lock signal UP or the phase-lock signal DWM in response to the slave-inductor signal V_{N}, the slave-switching signal S_{N}, and the start signal CLK_{N}. The start signal CLK_{N} is generated after a phase shift of the master-switching signal S₁. The phase-lock signal UP or the phase-lock signal DWN is produced in accordance with the period between the end of the slave-inductor signal V_{N} and the start of the slave-switching signal S_{N}.

FIG. 4 shows an embodiment of the phase-signal generator 105. A signal generator (“SIG”) 180 is coupled to receive the master-switching signal S₁ for generating a period signal E_{N}, a latch signal LTH, and a reset signal RST_{N}. The period signal E_{N} is proportional to the switching period of the master-switching signal S₁. The period signal E_{N} is coupled to enable a counter 125. An oscillator (“OSC”) 110 generates a clock signal which is connected to an input of an AND gate 112. Another input of the AND gate 112 is connected to the period signal E_{N}. The output of the AND gate 112 is connected to a clock-input of the counter 125. The latch signal LTH is connected to a register 135 for shifting output data N of the counter 125 into the register 135. It is a left shift and results a divided-by-two for the output data N of the counter 125. The reset signal RST_{N} is coupled to the reset-input of the counter 125 via an inverter 130 to reset the counter 125 after the output data N of the counter 125 was shifted into the register 135. The output data N of the counter 125 and the output data M of the register 135 are connected to a digital comparator 140. The digital comparator 140 generates the start signal CLK_{N} when the output data N of the counter 125 is larger than the output data M of the register 135 (N>M). The output of the digital comparator 140 is connected to an input of an AND gate 150. Another input of the AND gate 150 is connected to the period signal E_{N}. The start signal CLK_{N} is therefore generated at the output of the AND gate 150. The reset signal RST_{N} is generated before the generation of the start signal CLK_{N}. The reset signal RST_{N} is coupled to turn off the slave-switching signal S_{N}.

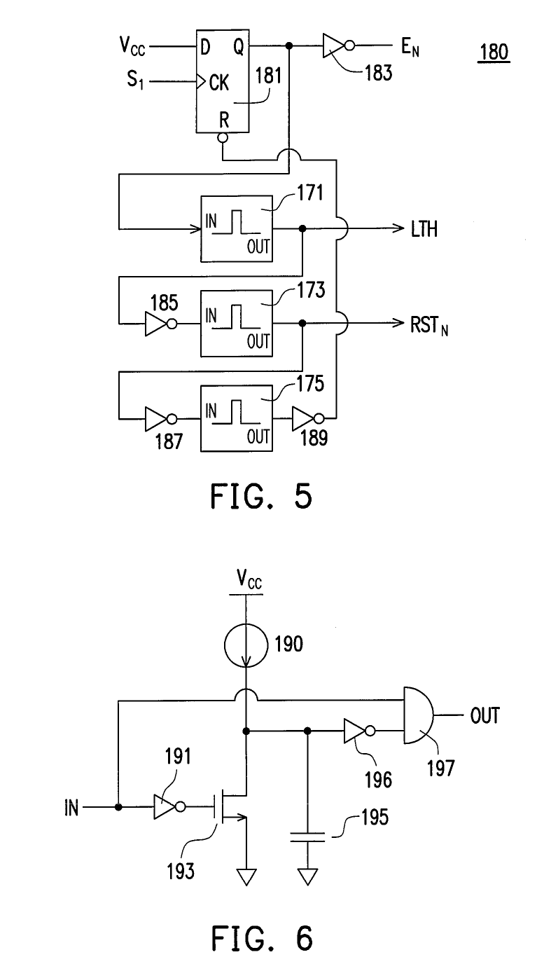

FIG. 5 shows an embodiment of the signal generator 180. The master-switching signal S₁ is connected to enable a flip-flop 181. The period signal E_{N} is produced at the output of the flip-flop 181 via an inverter 183. The output of the flip-flop 181 is further connected to a pulse generator 171 for producing the latch signal LTH. The latch signal LTH is connected to another pulse generator 173 through an inverter 185 for generating the reset signal RST_{N}. The reset signal RST_{N} is further connected to a pulse generator 175 through an inverter 187. The output of the pulse generator 175 is coupled to reset the flip-flop 181 via an inverter 189.

FIG. 6 shows an embodiment of a pulse generator. A current source 190 is utilized to charge a capacitor 195. A transistor 193 is connected to discharge the capacitor 195. The capacitor 195 is connected to an input of an AND gate 197 via an inverter 196. Another input of the AND gate. 197 is coupled to the input IN of the pulse generator. The input IN of pulse generator is further coupled to control the on/off of the transistor 193 via another inverter 191. Therefore, a pulse signal is generated in response to the enablement of the signal at the input IN of the pulse generator. The pulse width of the pulse signal is determined by the current of the current source 190 and the capacitance of the capacitor 195.

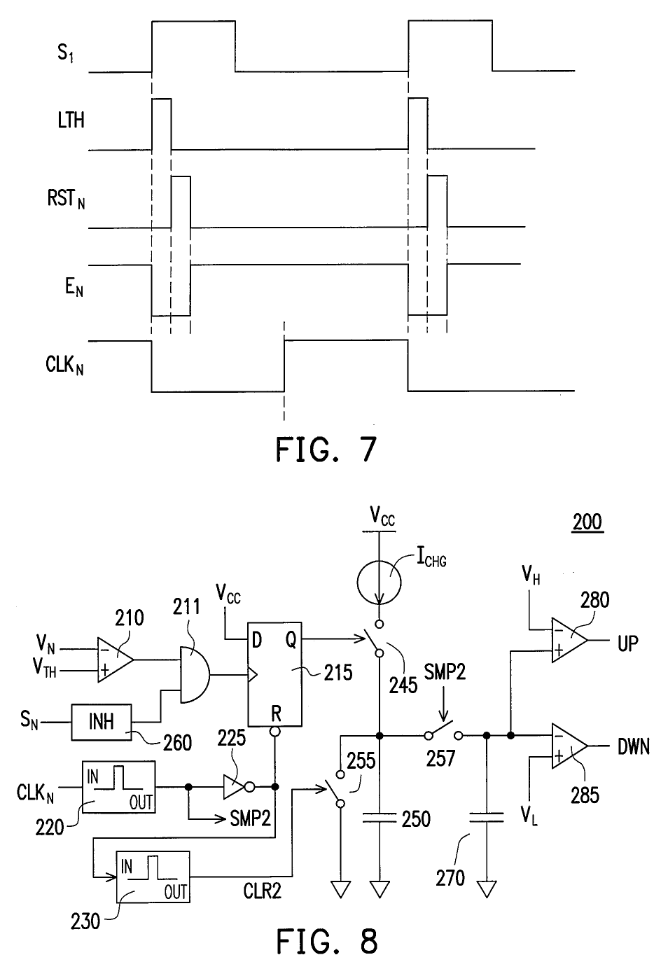

FIG. 7 shows signal waveforms. The period signal EN, the latch signal LTH, and the reset signal RST_{N} are generated in response to the enablement of the master-switching signal S₁. The reset signal RST_{N} is generated after the latch signal LTH is generated. The start signal CLK_{N} is generated after a phase shift of the master-switching signal S₁.

FIG. 8 shows an embodiment of the lock-signal generator 200. When the slave-switching signal S_{N} is turned off, a comparator 210 is coupled to generate a charge signal once the slave-inductor signal V_{N} is lower than a threshold signal V_{TH}. A flip-flop 215 generates the charge signal. The slave-inductor signal V_{N} and the threshold signal V_{TH} are connected to the inputs of the comparator 210. The output of the comparator 210 is connected to enable the flip-flop 215 through an AND gate 211. Another input of the AND gate 211 is connected to the slave-switching signal S_{N} through an inhibit circuit (“INH”) 260. The start signal CLK_{N} is connected to a pulse generator 220 to generate a sample signal SMP2. The sample signal SMP2 is further connected to disable the charge signal by resetting the flip-flop 215 via an inverter 225. The output of the inverter 225 is connected to another pulse generator 230 for producing a clear signal CLR2.

The current signal I_{CHG}, a capacitor 250, and switches 245 and 255 generate a differential signal in response to the charge signal. A switch 257 is further connected from the differential signal to a capacitor 270. The charge signal is connected to control the switch 245 for generating the differential signal. The sample signal SMP2 is connected to control the switch 257 for sampling the voltage of the differential signal to the capacitor 270. The clear signal CLR2 is connected to the switch 255 to discharge the capacitor 250 and reset the differential signal. A phase-delay is assigned to represent the period from the disablement of the slave-inductor signal V_{N} to the enablement of the slave-switching signal S_{N}. When the phase-delay is increased, the amplitude of the differential signal is increased accordingly. The maximum voltage of the differential signal is sampled to the capacitor 270. The capacitor 270 is further connected to comparators 280 and 285 for generating the phase-lock signal UP or the phase-lock signal DWN. Therefore, the phase-lock signal UP or the phase-lock signal DWN is produced in accordance with the period between the disablement of the slave-inductor signal V_{N} and the enablement of the slave-switching signal S_{N}. The phase-lock signal UP or the phase-lock signal DWN is in an UP state for increasing the on-time of the slave-switching signal S_{N} when the differential signal is higher than a threshold V_{H}. The phase-lock signal UP or phase-lock signal DWN is in a DWN state to decrease the on-time of the slave-switching signal S_{N} when the differential signal is lower than a threshold V_{L}.

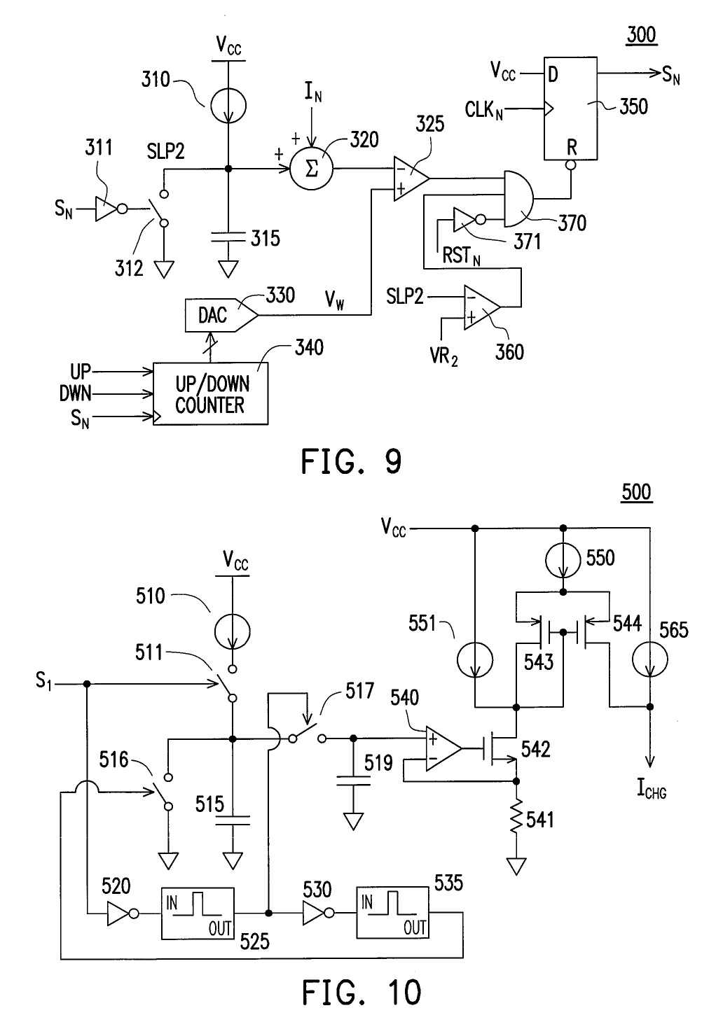

FIG. 9 shows an embodiment of the on-time-adjust circuit 300. It includes a flip-flop 350 coupled to enable the slave-switching signal S_{N} in response to the start signal CLK_{N}. A switch 312, a current source 310, a capacitor 315, and an inverter 311 develop a ramp-signal generator for generating a ramp signal SLP2 in response to the enablement of the slave-switching signal S_{N}. An adder 320 receives the ramp signal SLP2 and the slave-current signal I_{N} for generating a mixed signal coupled to the input of a comparator 325. The slave-current signal I_{N} is correlated to the switching current of the slave inductor 35. Another input of the comparator 325 is connected to receive an output signal V_{W} of a digital-to-analog converter 330. The digital-to-analog converter 330 generates the signal V_{W} in accordance with the output data of an up/down counter 340. The slave-switching signal S_{N} is connected to the clock-input of the up/down counter 340. The phase-lock signal UP/DWN is also coupled to the up/down counter 340 to determine the up-count or down-count. The phase-lock signal UP/DWN is coupled to control the output data of the up/down counter 340 and control the on-time of the slave-switching signal S_{N}.

Through an AND gate 370, the output of the comparator 325 is coupled to disable the slave-switching signal S_{N} in response to the comparison of the signal V_{W} and the mixed signal. Another comparator 360 is applied to disable the slave-switching signal S_{N} through the AND gate 370. The inputs of the comparator 360 are connected to the ramp signal SLP2 and a threshold voltage VR2. The slave-switching signal S_{N} is disabled once the ramp signal SLP2 is higher than the threshold voltage VR2, which limits the maximum on-time of the slave-switching signal S_{N}. Furthermore, another input of the AND gate 370 is coupled to the reset signal RST_{N} via an inverter 371. The reset signal RST_{N} is generated before the generation of the start signal CLK_{N}, and the slave-switching signal S_{N} is thus turned off before the enablement of the start signal CLK_{N}, which further limits the maximum duty cycle of the slave-switching signal S_{N}.

FIG. 10 shows the power management circuit 500. A current source 510, capacitors 515 and 519, and switches 511, 516, and 517 develop a time-to-voltage circuit to generate a voltage signal at the capacitor 519 in response to the pulse width (on-time) of the master-switching signal S₁. The master-switching signal S₁ is coupled to the switch 511 to enable the charge of the current source 510 to the capacitor 515. Through an inverter 520 and a pulse generator 525, the master-switching signal S₁ generates a sample signal to turn on or turn off the switch 517 for sampling the voltage of the capacitor 515 to the capacitor 519. Through an inverter 530 and another pulse generator 535, the sample signal further generates a clear signal connected to the switch 516 to clear the capacitor 515 after the sampling. The voltage signal of the capacitor 519 is connected to the input of an operational amplifier 540. The operational amplifier 540, a transistor 542, and a resistor 541 form a voltage-to-current circuit to generate a current at the transistor 542 in accordance with the voltage signal of the capacitor 519. The current of the transistor 542 is coupled to transistors 543 and 544. The transistors 543 and 544 form a current mirror and output a current at the transistor 544 in response to the current of the transistor 542. A current source 551 builds a threshold for generating the current at the transistor 544. A current source 550 determines the maximum values of the current of the transistor 544. The current of the transistor 544 and the current of a current source 565 form the current signal I_{CHG}. The current source 565 determines the minimum value of the current signal I_{CHG}. When the on-time of the master-switching signal S₁ is decreased, the voltage signal of the capacitor 519 is decreased as well. When the voltage signal of the capacitor 519 is decreased, the current signal I_{CHG} is decreased as well. The current source 551 determines the threshold. The decrease of the current signal I_{CHG} causes the decrease of the pulse width of the slave-switching signal S_{N} for power saving.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims or their equivalents.

What is claimed is:

1. A slave switching circuit for a master-slave power factor correction (PFC) converter, the slave switching circuit comprising:
a phase-detection circuit, coupled to detect a master-switching signal and a slave-inductor signal for generating a start signal and a phase-lock signal, wherein the start signal is utilized to enable a slave-switching signal, and the slave-switching signal is coupled to switch a slave inductor; and
an on-time-adjust circuit, coupled to adjust the on-time of the slave-switching signal in accordance with the phase-lock signal,
wherein the slave-inductor signal is correlated to the demagnetization of the slave inductor, and the phase-lock signal is coupled to minimize the period between the disablement of the slave-inductor signal and the enablement of the start signal.

2. The slave switching circuit as claimed in claim 1, further comprising:
a power management circuit, coupled to receive the master-switching signal for decreasing the on-time of the slave-switching signal when the on-time of the master-switching signal is decreased and its pulse width is lower than a threshold.

3. The slave switching circuit as claimed in claim 1, wherein the slave-switching signal is turned off before the enablement of the start signal, which determines the maximum duty cycle of the slave-switching signal.

4. The slave switching circuit as claimed in claim 1, wherein the start signal is generated in accordance with a switching period of the master-switching signal.

5. The slave switching circuit as claimed in claim 1, wherein the on-time-adjust circuit is developed to adjust the on-time of the slave-switching signal for minimizing the period between the disablement of the slave-inductor signal and the enablement of the start signal.

6. The slave switching circuit as claimed in claim 1, wherein the phase-detection circuit comprises:
a phase-signal generator, generating the start signal in accordance with a switching period of the master-switching signal; and
a lock-signal generator, generating the phase-lock signal in response to the slave-inductor signal and the slave-switching signal,
wherein the start signal is generated after a phase shift of the master-switching signal, and the phase-lock signal is produced in accordance with the period between the disablement of the slave-inductor signal and the enablement of the slave-switching signal.

7. The slave switching circuit as claimed in claim 1, wherein the on-time-adjust circuit comprises:
a flip-flop, coupled to enable the slave-switching signal in response to the start signal;
a ramp-signal generator, generating a ramp signal in response to the slave-switching signal;
an up/down counter, coupled to the phase-lock signal to generate a digital code;
a digital-to-analog converter, producing an analog signal in accordance with the digital code; and
a comparator, coupled to disable the slave-switching signal in response to the comparison of the analog signal and the ramp signal.

8. A method for providing an interleaved slave switching circuit for a master-slave PFC converter, the method comprising:
generating a slave-switching signal in response to a phase-lock signal, the slave-switching signal being coupled to switch a slave inductor; and
generating the phase-lock signal in accordance with a slave-inductor signal and the slave-switching signal, the phase-lock signal being coupled to control the on-time of the slave-switching signal,
wherein the slave-inductor signal is correlated to the demagnetization of the slave inductor, and the slave inductor is connected with a master inductor in parallel to the output of the PFC converter.

9. The method as claimed in claim 8, further comprising:
generating a start signal in accordance with a master-switching signal, the start signal being coupled to enable the slave-switching signal,
wherein the start signal is generated after a phase shift of the master-switching signal.

10. The method as claimed in claim 8, wherein the phase-lock signal is utilized to adjust the on-time of the slave-switching signal for minimizing the period between the disablement of the slave-inductor signal and the enablement of the slave-switching signal.

11. The method as claimed in claim 8, further comprising:
decreasing the on-time of the slave-switching signal in response to the on-time of the master-switching signal,
wherein the on-time of the slave-switching signal is decreased when the on-time of the master-switching signal is decreased and its pulse width is lower than a threshold.
